(19) United States
(12) Patent Application Publication
(10) Pub. No.: US 2003/0075876 A1
(43) Pub. Date: Apr. 24, 2003

(54) Seal system

(75) Inventor: Wolfgang Gonsior, Bodolz (DE)

Correspondence Address: CROWELL & MORING LLP, INTELLECTUAL PROPERTY GROUP, P.O. BOX 14300, WASHINGTON, DC, 20044-4300, US

(73) Assignee: XOMOX International GmbH & Co., Lindau-Bodensee (DE)

(21) Appl. No.: 10/224,583

(22) Filed: Aug. 21, 2002

Related U.S. Application Data
(63) Continuation of application No. PCT/EP01/01248, filed on Feb. 6, 2001.

(30) Foreign Application Priority Data
Feb. 23, 2000 (DE) 200 03 198.8
May 11, 2000 (DE) 200 08 526.3

(51) Int. Cl. F16J 15/02

(52) U.S. Cl. 277/628

(57) ABSTRACT

A seal system including a first sealing ring (32), especially a sealing ring of a high-temperature resistant material such as graphite, and a seal chamber (24) disposed between two components (2, 4) which can be joined to each other. The two components define an inner space (5) through which a fluid can flow, and are preferably joined via a flanged connection, with the sealing ring (32) disposed in the chamber (24) under prestress. The seal system provides a functional seal which requires but little space and can be produced and/or assembled at low cost. To this end a partition (34) is disposed in the seal chamber (24) radially inside the first sealing ring (32) with the first sealing ring supported by a radially outer surface of the partition. A second sealing ring, made of a soft sealing material such as polytetrafluoroethylene (PTFE), is disposed in the seal chamber radially inside the partition (34).

### CROSS REFERENCE TO RELATED APPLICATIONS

This application is a continuation of international patent application no. PCT/EP01/01248, filed Feb. 6, 2001, designating the United States of America, the entire disclosure of which is incorporated herein by reference. Priority is claimed based on Federal Republic of Germany patent applications no. DE 200 03 198.8, filed Feb. 23, 2000, and no. DE 200 08 526.3, filed May 11, 2000.

### BACKGROUND OF THE INVENTION

The invention relates to a seal system comprising a first sealing ring, particularly a ring made of a high-temperature sealing material such as graphite, disposed under prestress in a seal chamber between two components which can be joined and which enclose an interior space through which a fluid flows.

German Patent No. DE 503,769 discloses a pipe connection with such a seal system, which comprises two radially outer or radially inner sealing rings and a connecting piece that forms a partition and is arranged therebetween. The partition is disposed in a chamber of the two components to be joined and is configured as a double T-shaped ring with lateral flanges. When the two components are joined, the lateral flanges of the partition are bent and the sealing rings are pressed into the chamber. In other respects, the partition keeps its shape. In the event of fire, the two sealing rings, which are made of a soft sealing material, can be damaged or destroyed so that the seal is subsequently no longer assured.

Furthermore, U.S. Pat. No. 3,869,132 A discloses a seal system designed to be fire resistant, which comprises a first metallic sealing ring and a radially inner second sealing ring that is made of an elastomer. The first metallic sealing ring is especially C-shaped and fits radially outwardly against a chamber wall. If the second sealing ring is destroyed, the seal is formed exclusively by the first metallic sealing ring. Due to unevenness, scratches, or the like in the superimposed surfaces of the first sealing ring and the chamber walls, there is a risk of substantial leaks.

Also known are fire resistant seal systems that are configured as metal-graphite seals. To satisfy the requirement that the first sealing ring, which is at least partially made of graphite or a comparable high-temperature sealing material, cannot come into contact with the fluid flowing through the components, a second seal is provided on the fluid side. This requires a considerable amount of space. Furthermore, additional metal seals may be provided, which are costly and have a relatively high leakage rate.

### SUMMARY OF THE INVENTION

Accordingly, it is the object of the invention to provide an improved seal system of the type described above.

Another object of the invention is to provide a seal system which assures a functionally reliable seal at low production and/or installation costs.

An additional object of the invention is to provide a seal system which requires only a little space and no additional parts or process steps.

A further object is to provide a seal system which satisfies fire safety requirements and is resistant to the fluid flowing through the components, particularly to chemicals.

These and other objects are achieved in accordance with the present invention by providing a seal system comprising first and second components which are joined together and enclose an interior space through which a fluid flows. The first and second components further define a seal chamber between them, and a partition is arranged in the seal chamber between the first and second components. A first sealing ring is arranged in the seal chamber radially outside of and supported by the partition, and a second sealing ring made of a soft sealing material is arranged in the seal chamber radially inside the partition. The first sealing ring is made of a high-temperature sealing material. When the first and second components are joined, the partition is radially deformed such that the first sealing ring is radially prestressed.

The seal system according to the invention has a simple structure and is distinguished by its high functional reliability. It requires very little space. A second fluid-side soft sealing ring is associated with the first sealing ring. A partition, particularly in the form of a metal ring, is arranged between these sealing rings. This creates a sandwich type sealing element, which is preferably configured as a flat seal and is ready to be installed in the chamber.

The partition is clamped between the components when they are joined and is deformed in such a way that the volume of the first sealing ring is reduced and the first sealing ring is thereby enclosed and compressed. The metal ring prestresses the first sealing ring, particularly in radial direction. This prestress is maintained even if the second sealing ring is damaged or destroyed, particularly as a consequence of fire, so that a reliable outward seal is assured. The partition is substantially more rigid than the first sealing ring, which is thus always functionally reliably supported by the partition, independent of the second soft sealing ring, and is prestressed and/or compressed as required in the partial chamber, which is separated by the partition.

The partition or the metal ring is deformed during installation because the contact surfaces of the partition rest against both a chamber wall of the one component and a chamber wall of the other component, and the distance between these chamber walls is reduced when the seal is installed and/or when the components are joined. The partition is advantageously preformed in such a way that the volume of the chamber part containing the first sealing ring is also changed by the partition and preferably reduced to compress the first sealing ring.

The sealing element according to the invention performs a dual function, namely to provide a seal that is resistant to fire and resistant to chemicals. It requires very little space and is a cost-effective solution without requiring any additional parts or process steps.

The soft second sealing ring, which is made, in particular, of polytetrafluoroethylene (PTFE), an elastomer or a similar material; is arranged on the other side of the partition. The sealing element according to the invention is thus configured as a prefabricated component and is arranged in one and the same chamber, which is formed by projections, tongue and groove arrangements, or the like of the two components. In relation to the first sealing ring and the partition, the second soft-elastic sealing ring is arranged on the fluid side and thus prevents the fluid from coming into contact with the partition or the first sealing ring. If the first sealing ring is destroyed by fire or other external influences, the inventive annular partition, which is clamped between the components, nevertheless maintains the enclosure of the first sealing ring and thereby also ensures a reliable outward seal.

In normal operation, the second sealing ring, which is made of PTFE or some other soft sealing material, prevents the first sealing ring, which is made of graphite or some other high-temperature sealing material, from coming into contact with the fluid which passes through the components. The three rings advantageously form a prefabricated and/or integral sealing element, which is inserted into a single chamber for installation.

The annular partition located between the first and second sealing ring is clamped therebetween when the components are assembled and joined and is further deformed in such a way that the first sealing ring is compressed and at the same time completely enclosed. To increase its rigidity, the partition is preferably provided with a rib, which projects particularly into the partial chamber of the first sealing ring. This rib is preferably formed by the deformation of the partition, particularly by buckling and/or compression during installation. The rib forms an integral part of the partition, which has preferably a substantially uniform thickness and/or is approximately triangularly deformed in the direction of the longitudinal axis.

In the seal system according to the invention, the aforementioned three rings are advantageously arranged coaxially to one another, with the first sealing ring forming the outer ring and the second sealing ring the inner ring, between which the advantageously preformed partition is arranged. The axial width of the second or inner sealing ring is advantageously smaller than the axial width of the metal ring and/or the first or outer sealing ring. During installation, the distance between the axially opposite chamber walls of the two components is reduced, and after installation is complete the two sealing rings are firmly pressed into the chamber under prestress. The partition with the aforementioned contact surfaces fits tightly and/or under prestress against the chamber walls, which are axially opposite and/or in substantially radial planes.

Further developments and special embodiments of the invention will now be described with reference to an exemplary embodiment. The seal system is preferably used in valves, cocks or gates, and the aforementioned components are housing parts thereof. It should be noted, however, that the inventive seal system can be used for components of various types, e.g., pipe parts, housing parts, etc.

### BRIEF DESCRIPTION OF THE DRAWINGS

The invention will be described in further detail hereinafter with reference to an illustrative preferred ball valve embodiment shown in the accompanying drawings, in which:

FIG. 1 is an axial longitudinal section through a ball valve with the inventive seal system between the two components, which are configured as housing parts;

FIG. 2 is an enlarged detail of FIG. 1;

FIG. 3 is a partial axial section through the inventive integral sealing element prior to installation or prior to clamping between the components; and

FIG. 4 shows the sealing element of FIG. 3 after installation.

### DETAILED DESCRIPTION OF PREFERRED EMBODIMENTS

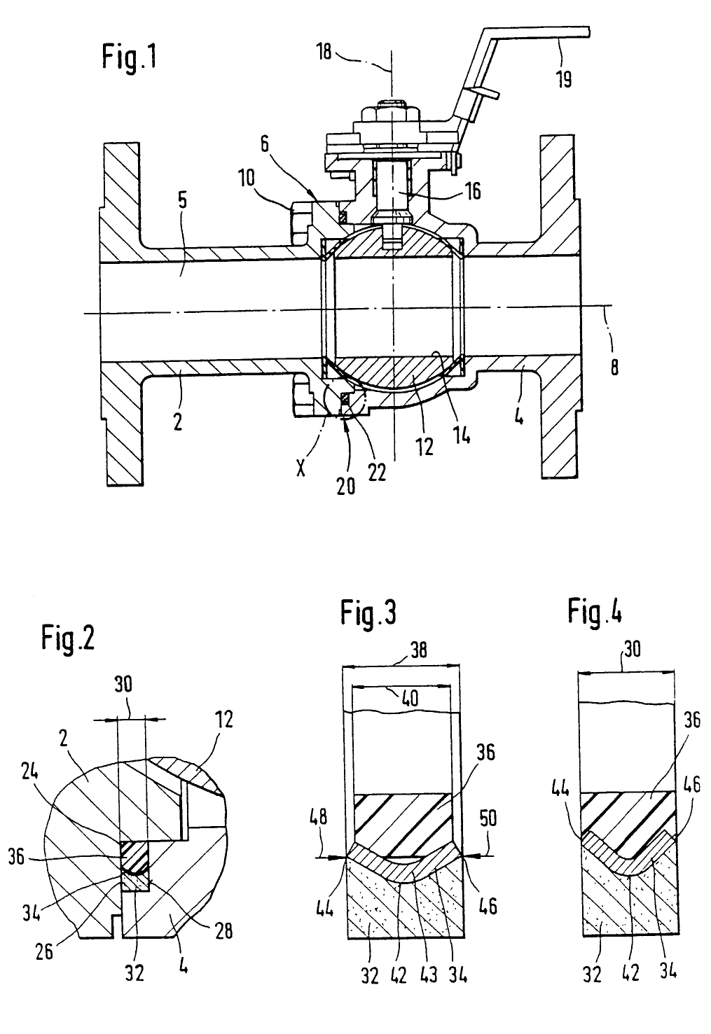

According to FIG. 1, two components 2, 4 by way of example are configured as the housing parts of a ball valve enclosing an interior space 5 through which a fluid flows. They are joined by means of a flange connection 6. A plurality of screws 10 is distributed in known manner around the circumference, i.e., relative to a longitudinal axis 8. In housing part 4, a valve ball 12 with a through opening 14 is supported by a stem 16 so as to be rotatable about an axis 18.

To actuate the ball valve, a lever 19 is non-rotatably coupled with stem 16. By turning this lever 90°, the valve ball 12 can be rotated out of its depicted open position into its locked position in which the axis of the through opening 14 is disposed perpendicularly to longitudinal axis 8. In the junction area 20 of the two housing or component parts 2, 4, an annular sealing element 22 is arranged in a chamber 24 between the two component parts 2, 4.

According to FIG. 2, chamber 24 is formed on the one hand by an annular groove 24 made in component 4 and on the other hand by an annular collar made in component 2. Chamber 24 has a substantially rectangular cross section. There are two chamber walls 26, 28, which are diametrically and axially spaced apart. Chamber 24 is furthermore bounded by two diametrically and radially spaced apart chamber walls of components 2 or 4. When components 2, 4 are assembled, chamber walls 26, 28 are spaced apart at an axial distance 30.

The inventive sealing element, which is configured as a flat sandwich type seal, is arranged in chamber 24. It comprises a first sealing ring 32, a partition configured as a metal ring 34, and a second sealing ring 36. The first sealing ring 32 is preferably made of graphite or a comparable high-temperature sealing material, while the second sealing ring 36 is a soft seal preferably made of PTFE, an elastomer or some other soft sealing material. The second sealing ring 36 is arranged in front of metal ring 34. and/or the first sealing ring 32 as seen in the direction of ball 12, which is associated with interior space 5 through which the fluid of the ball valve flows. Consequently, the second sealing ring 36 protects sealing ring 32 as well as partition 34 or the metal ring against the influences of the fluid passing through interior space 5.

In this particular embodiment, the first sealing ring 32, metal ring 34 and second sealing ring 36 are arranged coaxially, i.e., relative to the longitudinal axis 8 of the two components 2, 4 or the ball valve. The first sealing ring 32 forms an outer ring and the second sealing ring 36 an inner ring, with the metal ring 34 arranged therebetween.

FIG. 3 shows the sealing element prior to installation or prior to being set into the aforementioned chamber between the components. Compared to the axial width 38 of the first sealing ring 32, the axial width 40 of the inner ring or second sealing ring 36 is smaller by a predefined amount. The radial thickness of the metal ring 34 is substantially constant over the axial length. The metal ring 34 is preformed in V-shape and in particular has a radially outward directed rib 43 with a point or a rounded projection 42, which faces the first sealing ring 32.

Furthermore, metal ring 34 comprises diametrically arranged contact surfaces 44, 46 that are axially spaced apart from one another and fit against the aforementioned axially opposite chamber walls of the two components. For installation, the inventive pre-assembled integral sealing element, which is ready to be installed, is inserted into the chamber. As the sealing element is installed or as the two components are joined, axial forces act on metal ring 34 in the direction of arrows 48, 50. This causes further deformation of metal ring 34 such that the point or rounded part 42 and the axially adjacent partial areas of metal ring 34 on either side are deformed radially outwardly.

Thus, the first sealing ring 32 is prestressed or compressed during installation and, in addition, an inventive enclosure is effected by means of metal ring 34. During installation, the chamber walls are moved toward one another far enough so that the soft second sealing ring 36 also finally fits against the aforementioned axially opposite chamber walls, advantageously under prestress, so as to form a seal. It should be expressly noted that the chamber is dimensioned in such a way that after installation is complete, the two sealing rings 32, 36 advantageously also fit in radial direction against the radially opposite chamber walls.

FIG. 4 shows the sealing element after installation is complete. Compared to FIG. 3, the deformation of the cross-sectionally V-shaped metal ring 34 is clearly visible here. It may be seen that the metal ring 34 with its contact surfaces 44, 46 fits prestressed and tightly against the axially opposite chamber walls. The axial width of the sealing element corresponds to distance 30 of the aforementioned chamber walls as described with reference to FIG. 2. Metal ring 34 forms the partition for the first sealing ring 32 in the direction of the fluid side such that if the second sealing ring 36 is damaged or destroyed, particularly due to fire, the enclosure of the first sealing ring 32 remains unchanged, and consequently a reliable outward seal is assured.

The foregoing description and examples have been set forth merely to illustrate the invention and are not intended to be limiting. Since modifications of the described embodiments incorporating the spirit and substance of the invention may occur to persons skilled in the art, the invention should be construed broadly to include all variations falling within the scope of the appended claims and equivalents thereof.

What is claiamed is:

1. A seal system comprising:
first and second components which are joined together and enclose an interior space through which a fluid flows, said first and second components further defining a seal chamber between them,
a partition arranged in said seal chamber between said first and second components,
a first sealing ring arranged in said seal chamber radially outside of and supported by said partition, and
a second sealing ring made of a soft sealing material arranged in said seal chamber radially inside said partition;
wherein said first sealing ring is made of a high-temperature sealing material, and wherein when said first and second components are joined, the partition is radially deformed such that said first sealing ring is radially prestressed.

2. A seal system according to claim 1, wherein said first and second components are joined by a flange connection.

3. A seal system according to claim 1, wherein said second sealing ring is made of polytetrafluoroethylene.

4. A seal system according to claim 1, wherein said partition is more rigid than said first sealing ring.

5. A seal system according to claim 1, wherein said partition is a metal ring which forms an enclosure within said seal chamber for said first sealing ring.

6. A seal system according to claim 1, wherein said first sealing ring is made of graphite.

7. A seal system according to claim 1, wherein said partition is clamped between two diametrically opposite chamber walls of the two components, and the distance between the two opposite chamber walls is reduced when said first and second components are joined.

8. A seal system according to claim 1, wherein when said first and second components are joined, said partition is deformed such that the seal chamber part containing the first sealing ring is reduced in volume and said first sealing ring is compressed.

9. A seal system according to claim 1, wherein said partition is configured as a circumferentially closed ring and is provided with a rib to impart rigidity.

10. A seal system according to claim 9, wherein the partition is arranged in annular contact with opposed chamber walls of said seal chamber between said first and second components.

11. A seal system according to claim 9, wherein said rib comprises an integral point or rounded portion which faces said first sealing ring.

12. A seal system according to claim 1, wherein said first sealing ring, said partition, and said second sealing ring comprise a pre-assembled sealing element sandwich.

13. A seal system according to claim 1, wherein before said first and second components are joined, said second sealing ring has a smaller axial width than said first sealing ring or said partition.

14. A seal system according to claim 1, wherein said first and second components comprise part of a valve, a cock, or a gate.
